(19) United States
(12) Patent Application Publication
(10) Pub. No.: US 2007/0237376 A1
(43) Pub. Date: Oct. 11, 2007

(54) IMAGE INTERPRETATION REPORT PREPARING APPARATUS AND IMAGE INTERPRETATION REPORT PREPARING SYSTEM

(76) Inventor: Akihiko Yoshida, Otawara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,704

(22) Filed: Mar. 22, 2007

(30) Foreign Application Priority Data
Mar. 27, 2006 (JP) 2006-085870

(51) Int. Cl. G06K 9/00; G06T 1/00

(52) U.S. Cl. 382/128; 345/418

(57) ABSTRACT

An image interpretation report preparing apparatus that accesses an image storage device storing a medical image and prepares an image interpretation report including at least link information for referring to the stored medical image includes a display unit that displays the image interpretation report. A mark displaying unit displays a mark for designating the link information included in the image interpretation report, on the display unit. A thumbnail image displaying unit displays a thumbnail image of the medical image correlated to the link information on the display unit, when the mark approaches the link information.

### CROSS-REFERENCE TO RELATED APPLICATIONS

This application is based upon and claims the benefit of priority from prior Japanese Patent Application No. 2006-085870, filed Mar. 27, 2006, the entire contents of which are incorporated herein by reference.

### BACKGROUND OF THE INVENTION

1. Field of the Invention

The present invention relates to an image interpretation report preparing apparatus and an image interpretation report preparing system that prepare an electronic image interpretation report from the image interpretation result of a medical image.

2. Description of the Related Art

An image interpretation report preparing apparatus in which an image interpretation doctor interprets a medical image that is scanned by modalities such as an X-ray photographing equipment, CT equipment, and MRI equipment to prepare an image interpretation report from the result of the image interpretation has already been put to practical use. According to this image interpretation report preparing apparatus, for example, the medical image photographed by medical image diagnostic equipment is displayed on special image viewer. The image interpretation doctor or the like registers the opinion of the medical image displayed on the image viewer in the opinion column of the image interpretation report and registers the diagnostic result in a diagnostic column on the basis of the opinion of the medical image. Furthermore, the image interpretation doctor appends the medical image to the image interpretation report, if necessary. Thereby, the image interpretation doctor prepares the image interpretation report.

An example of the image interpretation report preparing apparatus as described above has been proposed in, for example, JP-A-2005-301453. In JP-A-2005-301453, a key image is prepared by giving link information for showing the association between the medical image appended to the image interpretation report and a character string designated within the image interpretation report.

Here, according to the technique described in JP-A-2005-301453, in order to confirm the content of the linked medical image, it is necessary to actually select an appropriate character string and display the medical image responding to the selected character string on the image viewer. In addition, since it is necessary to close the medical image displayed on the image viewer after the termination of confirmation, operation becomes complex easily.

### BRIEF SUMMARY OF THE INVENTION

An advantage of some aspects of the invention is that it provides an interpretation report preparing apparatus and an interpretation report preparing system that can confirm the content of a linked medical image by a simple operation.

According to a first aspect of the invention, there is provided an image interpretation report preparing apparatus that accesses an image storage device storing a medical image and prepares an image interpretation report including at least link information for referring to the stored medical image. The apparatus includes a display unit that displays the image interpretation report; a mark displaying unit that displays a mark for designating the link information included in the image interpretation report, on the display unit; and a thumbnail image displaying unit that displays a thumbnail image of the medical image correlated to the link information on the display unit, when the mark approaches the link information.

According to a second aspect of the invention, there is provided an image interpretation report preparing apparatus that prepares an image interpretation report including link information for referring to a medical image stored in an image storage device. The apparatus includes a display unit that displays the image interpretation report; a mark displaying control unit that displays on the display unit a mark for designating link information included in the image interpretation report displayed on the display unit; an input unit that operates the mark on a display screen of the display unit; and a thumbnail image displaying control unit that displays on the display unit a thumbnail image of the medical image correlated to the link information, when the mark approaches the link information on the display screen by the operation of the input unit.

According to a third aspect of the invention, there is provided an image interpretation report preparing system. The system includes an image storage unit that stores a medical image; an image interpretation report preparing unit that prepares an image interpretation report including at least link information for referring to the stored medical image; a display unit that displays the image interpretation report; a mark displaying unit that displays a mark for designating the link information included in the image interpretation report, on the display unit; and a thumbnail image displaying unit that displays a thumbnail image of the medical image correlated to the link information on the display unit, when the mark approaches the link information.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an image interpretation report preparing system according to a first embodiment of the invention;

FIG. 2 is a flow chart showing a preparing process of the image interpretation report in the image interpretation report preparing system of FIG. 1;

FIG. 3 is a view showing a display example of a thumbnail image when a point is approached;

FIG. 4 is a flow chart showing a displaying process of a medical image on the image interpretation report display in the image interpretation report preparing system of FIG. 1;

FIG. 5 is a view showing a display termination example of a thumbnail image when a point is kept away;

FIG. 6 is a flowchart showing a preparing process of the image interpretation report in case of storing the thumbnail image in an image server;

FIG. 7 is a flowchart showing a displaying process of a medical image on the image interpretation report display in case of storing the thumbnail image in an image server;

FIG. 8 is a flowchart showing a preparing process of the image interpretation report in case of storing the thumbnail image in PC;

FIG. 9 is a flowchart showing a displaying process of a medical image on the image interpretation report display in case of storing the thumbnail image in PC;

FIG. 10 is a view showing an example of a case which changes the display position of the thumbnail image depending on the position of the pointer and the linked character string; and

FIG. 11 is a view showing an example of a case where an opinion column and a display column of the thumbnail image are separately provided.

### DETAILED DESCRIPTION OF THE INVENTION

Preferred embodiments of the invention will be described hereinafter with reference to the accompanying drawings.

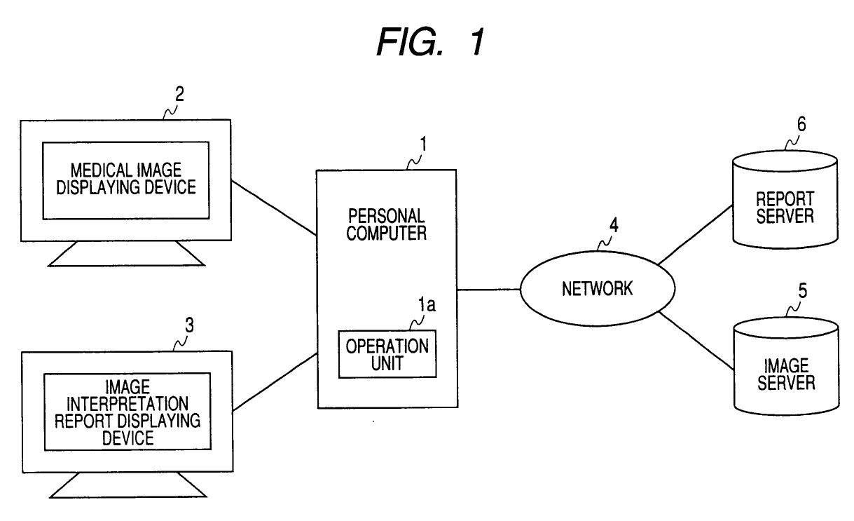

FIG. 1 is a view showing a configuration of an image interpretation report preparing system according to a first embodiment of the invention. The image interpretation report preparing system shown in FIG. 1 includes a personal computer (hereinafter, referred to as PC) 1, a medical image displaying device 2, an image interpretation report displaying device 3, a network 4, an image server 5, and a report server 6.

PC 1 is a computer in which an application for displaying a medical image and an application for preparing an image interpretation report are installed. The applications are necessary for preparing an electronic diagnostic report. PC 1 is provided with an operation unit la configured with, for example, a pointing device such as a mouse or a key board. In addition, PC 1 is communicatively connected to the image server 5 and the report server 6 through the network 4.

The medical image displaying device 2 is an image viewer that displays the medical image in accordance with the process of the application for displaying the medical image. The image interpretation report displaying device 3 displays an image interpretation report preparing screen such that an image interpretation doctor prepares the image interpretation report in accordance with the process of the application for preparing the image interpretation report. In addition, the image interpretation report displaying device 3 displays the image interpretation report that is already prepared. Moreover, the medical image displaying device 2 and the image interpretation report displaying device 3 may be also made up of one display device. In this case, a display area for displaying the medical image and a display area for displaying the image interpretation report are divided from each other to display.

The network 4 is a network for communicatively connecting PC 1, the image server 5, and the report server 6 with one another and is made up of, for example, LAN.

The medical image obtained by modalities (X-ray photographing device, CT device, MRI device or the like) not shown is stored in the image server 5.

The image interpretation report prepared as an interpreting result of a key image displayed on the medical image displaying device 2 is stored in the report server 6. Here, according to this embodiment of the invention, a sentence on the image interpretation report and the medical image in the image server 5 may be linked. When it is linked, link information for correlating the character string of the image interpretation report and the medical image is also stored in the report server 6. Furthermore, in case of being linked, the linked thumbnail image of the medical image is also associatively stored in the report server 6.

Hereinafter, an operation of the image interpretation report preparing system according to this embodiment of the invention will be described.

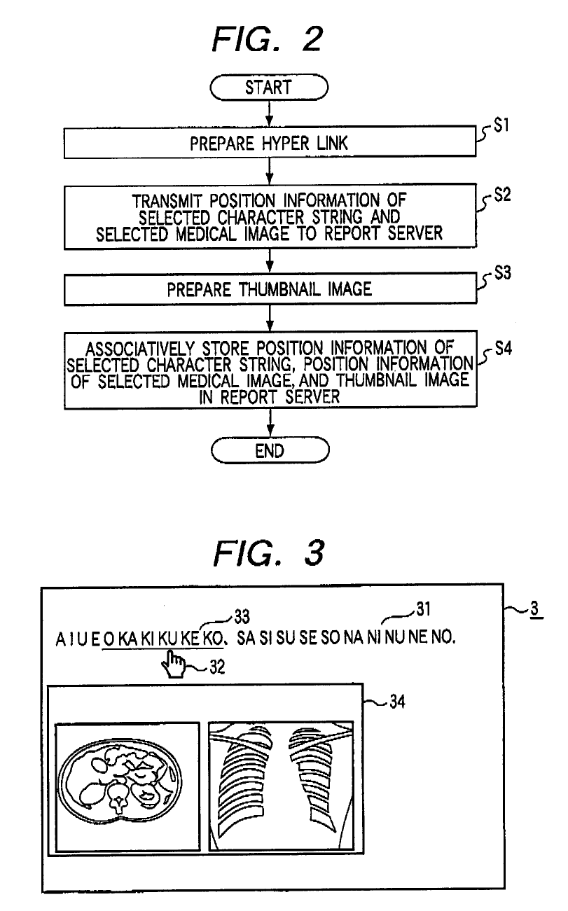

FIG. 2 is a flow chart showing a preparing process of the image interpretation report in the image interpretation report preparing system of FIG. 1.

First, the image interpretation report is prepared by an image interpretation doctor who inspects the medical image displayed on the medical image displaying device 2, and the character string in the prepared image interpretation report and the medical image are linked with each other (step S1). As shown in FIG. 3, the image interpretation report is provided with an opinion column 31 for registering an opinion with respect to the medical image displayed on the medical image displaying device 2, which is inspected by the image interpretation doctor or the like. At this time, a mark (pointer) 32 is also displayed on the image interpretation report displaying device 3. The mark 32 is to conduct various designating operation that selects the sentence in the opinion column 31 or an inputting operation of the opinion. When the image interpretation report is prepared, the image interpretation doctor or the like moves the pointer 32 by the operation unit la and inputs the opinion in the opinion column 31 by inputting the character.

Here, when the sentence of the opinion column 31 is linked to the medical image within the image server 5, for example, the medical image displayed on the medical image displaying device 2 is selected. At this time, the selected medical image is appended to a prescribed character string 33 of the image interpretation report displayed on the image interpretation report displaying device 3 by, for example, drag and drop operation. When the link operation (hyper link) is performed, the position information of the selected character string 33 and the medical image appended to the image interpretation report are transmitted to the report server 6 (step S2).

When the position information of the selected character string 33 and the medical image are transmitted, a thumbnail image of the medical image to be transmitted is prepared in the report server 6 (step S3). And then, the position information of the selected character string 33, the position information of the medical image (address information within the image server 5) linked to this character string 33, and the thumbnail image are associatively stored in the report server 6, respectively (step S4). For this reason, the hyper link is prepared in the character string 33 within the image interpretation report. Here, when the hyper link is prepared in the character string 33 within the image interpretation report, an under line is attached to the character string 33 so as to view the set of the hyper link, as shown in FIG. 3.

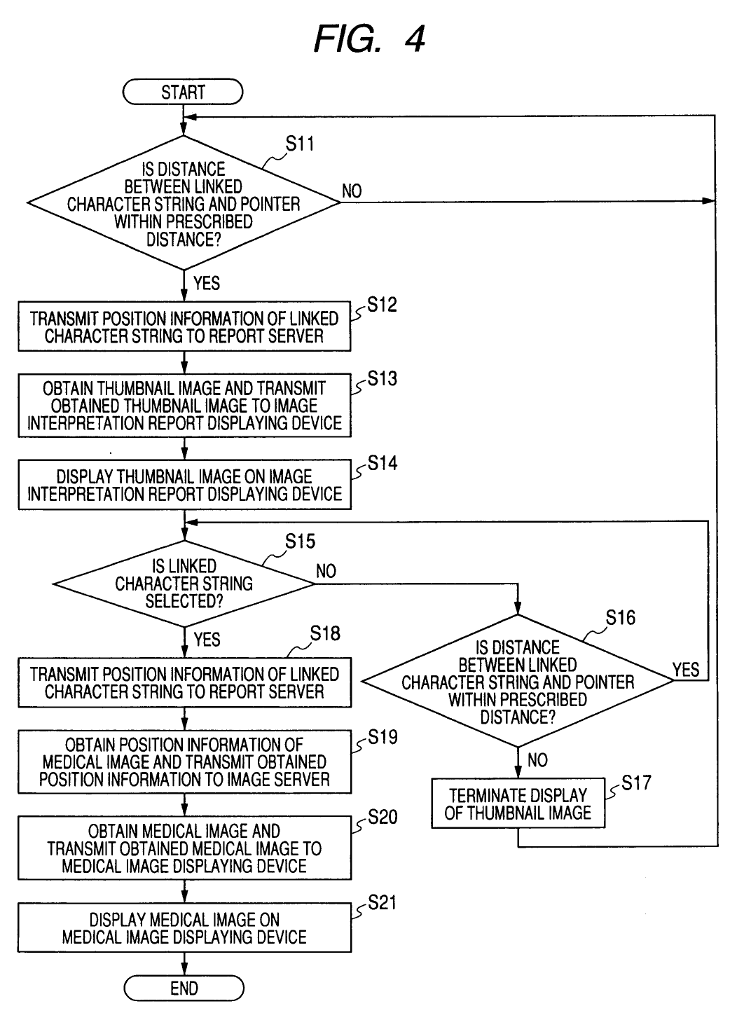

FIG. 4 is a flow chart showing a displaying process of a medical image on the image interpretation report display in the image interpretation report preparing system of FIG. 1.

When the image interpretation report is displayed on the image interpretation report displaying device 3, it is determined whether or not the distance between the linked character string 33 and the pointer 32 is within a prescribed distance (step S11). Then, if it is determined that the distance between the linked character string 33 and the pointer 32 approaches up to a prescribed distance in step S11, the position information of the linked character string 33 is transmitted to the report server 6 (step S12). When the position information of the character string 33 is transmitted, the thumbnail image correlated to the character string 33 is obtained, and the obtained thumbnail image is transmitted to the image interpretation report displaying device 3 through PC 1 (step S13). Then, the thumbnail image 3 of the medical image correlated to the character string 33 is displayed on the image interpretation report displaying device 3 (step S14), as shown in FIG. 3.

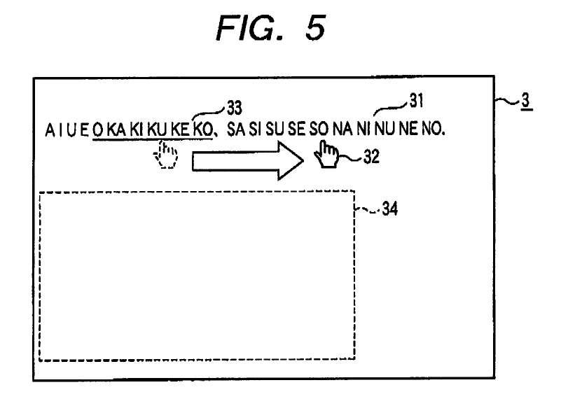

Then, the image interpretation doctor determines whether or not the character string 33 is selected (step S15). If it is determined that the character string 33 is not selected in step S15, it is determined whether the distance between the character string 33 and the pointer 32 is within a prescribed distance or not (step S16). When it is determined that the distance between the character string 33 and the pointer 32 is within a prescribed distance in step S16, the process returns to step S15 and the display of the thumbnail image 34 is continued. Moreover, if the distance between the character string 33 and the pointer 32 is not within a prescribed distance in step S16, the display of the thumbnail image 34 is terminated (step S17). This is the case where the pointer 32 goes away from the character string 33, as shown in FIG. 5.

In addition, if it is determined that the character string 33 is selected in step S15, the position information of the linked character string 33 is transmitted to the report server 6 (step S18). When the position information of the character string 33 is transmitted, the position information of the medical image that is correlated to the character string 33 is obtained. At this time, this position information is transmitted to the image server 5 (step S19). When the position information of the medical image that is correlated to the character string 33 is transmitted to the image server 5, the medical image is obtained on the basis of this position information. The obtained medical image is transmitted to the medical image displaying device 2 through PC 1 (step S20). Then, the medical image correlated to the character string 33 is displayed on the medical image displaying device 2 (step S21).

As described above, according to this embodiment of the invention, it is possible to display the thumbnail image 34 of the medical image corresponding to the character string only by bringing the pointer 32 close to the linked character string 33 within the image interpretation report. In addition, it is possible to terminate the display of the thumbnail image 34 only by keeping away the pointer 32 from the character string 33. Therefore, it is possible to confirm the content of the medical image corresponding to the linked character string by the handy operation.

Hereinafter, a modification example of the above-described embodiment will be described. First, the example that stores the thumbnail image of the medical image in the report server 6 will be described in the above-described embodiment, but the storage location of the thumbnail image is not limited to the report server 6.

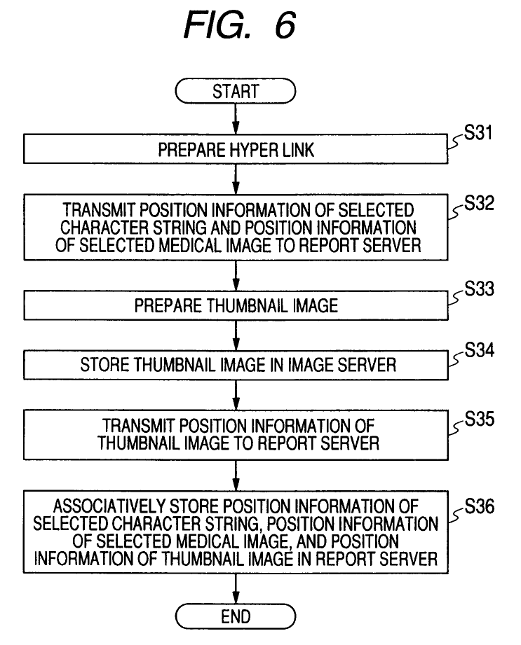

FIG. 6 is a flowchart showing a preparing process of the image interpretation report in case of storing the thumbnail image in the image server 5.

First, the image interpretation report is prepared by the image interpretation doctor who inspects the medical image displayed on the medical image displaying device 2, and the character string within the prepared image interpretation report and the medical image are linked to each other (step S31). When the link-attachment (hyper link) is operated, the position information of the selected character string 33 and the position information of the medical image appended to the image interpretation report are transmitted to the report server 6 (step S32).

In parallel with the transmission of the position information of the selected character string 33 and the position information of the medical image, the thumbnail image of the medical image correlated to the character string 33 is prepared in the image server 5 (step S33). The prepared thumbnail image is correlated to the medical image and is stored in the image server 5 (step S34). Then, the position information (address information within the image server 5) of the thumbnail image is transmitted to the report server 6 (step S35). In the report server 6, the position information of the selected character string 33, the position information of the medical image linked to this character string 33, and the position information of the thumbnail image are associatively stored in the report server 6, respectively (step S36).

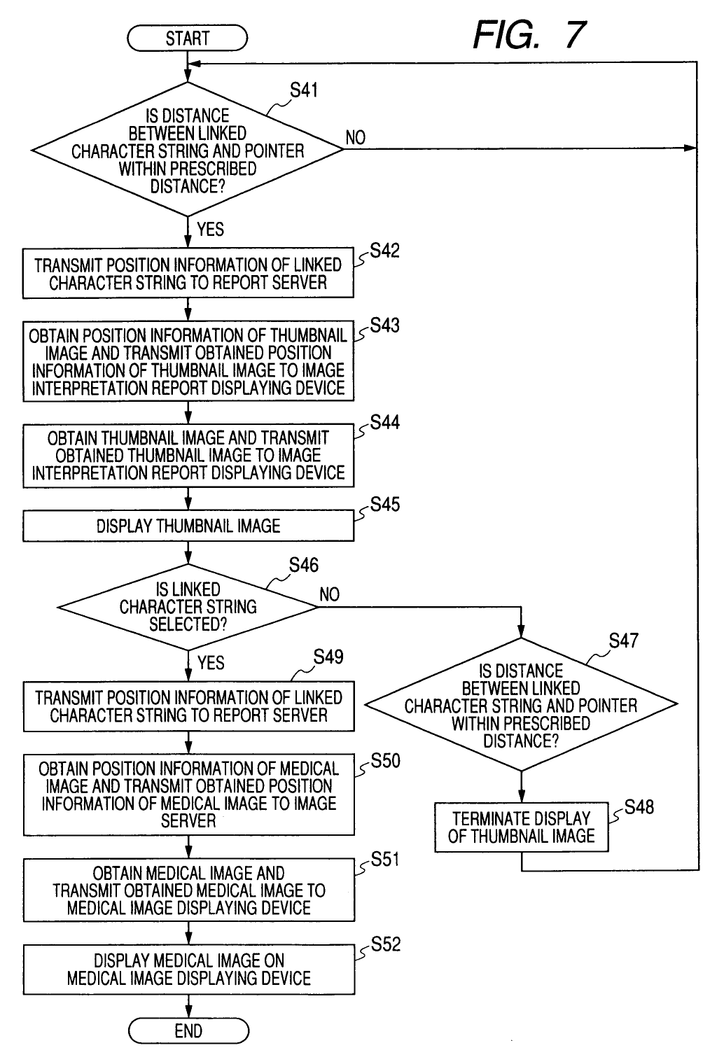

FIG. 7 is a flowchart showing a displaying process of the medical image on the image interpretation report display in case of storing the thumbnail image in the image server 5.

When the image interpretation report is displayed on the image interpretation report displaying device 3, it is determined whether or not the distance between the linked character string 33 and the pointer 32 is within a prescribed distance (step S41). Then, if it is determined that the distance between the linked character string 33 and the pointer 32 approaches up to a prescribed distance in step S41, the position information of the linked character string 33 is transmitted to the report server 6 (step S42). When the position information of the character string 33 is transmitted, the position information of the thumbnail image correlated to the character string 33 is obtained. Moreover, the obtained position information of the thumbnail image is transmitted to the image server 5 (step S43). When the position information of the thumbnail image is transmitted, the thumbnail image is obtained on the basis of this position information in the image server 5, and the obtained thumbnail image is transmitted to the image interpretation report displaying device 3 (step S44). Then the thumbnail image 34 of the medical image correlated to the character string 33 is displayed on the image interpretation report displaying device 3 (step S45), as shown in FIG. 3. In addition, the following processes of step S46 to step S52 are the same as in FIG. 4. Accordingly, the description thereof will be omitted.

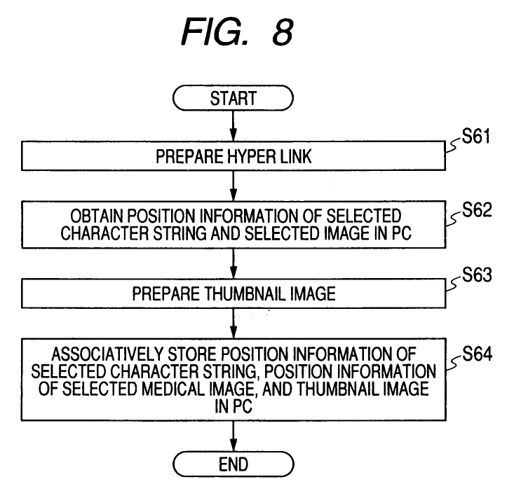

FIG. 8 is a flowchart showing a preparing process of the image interpretation report in case of storing the thumbnail image in PC 1. This process is executed, for example, when PC 1 has a function of the report server 6.

First, the image interpretation report is prepared by the image interpretation doctor who inspects the medical image displayed on the medical image displaying device 2, and the character string within the prepared image interpretation report and the medical image are linked to each other (step S61). When the above link-attachment (hyper link) is operated, the position information of the selected character string 33 and the medical image appended to the image interpretation report are obtained in PC 1 (step S62).

When the position information of the selected character string 33 and the medical image are obtained, the thumbnail image of the medical image appended to the image interpretation report is prepared in PC 1 (step S63). Then the position information of the selected character string 33, the position information of the medical image linked to this character string 33, and the thumbnail image are associatively stored in PC 1, respectively (step S64). Therefore, the hyper link is prepared in the character string 33 within the image interpretation report. As described above, since the thumbnail image is stored in PC 1, it is not necessary to use the network when the image is displayed. Accordingly, it is possible to shorten the time until the thumbnail image is displayed.

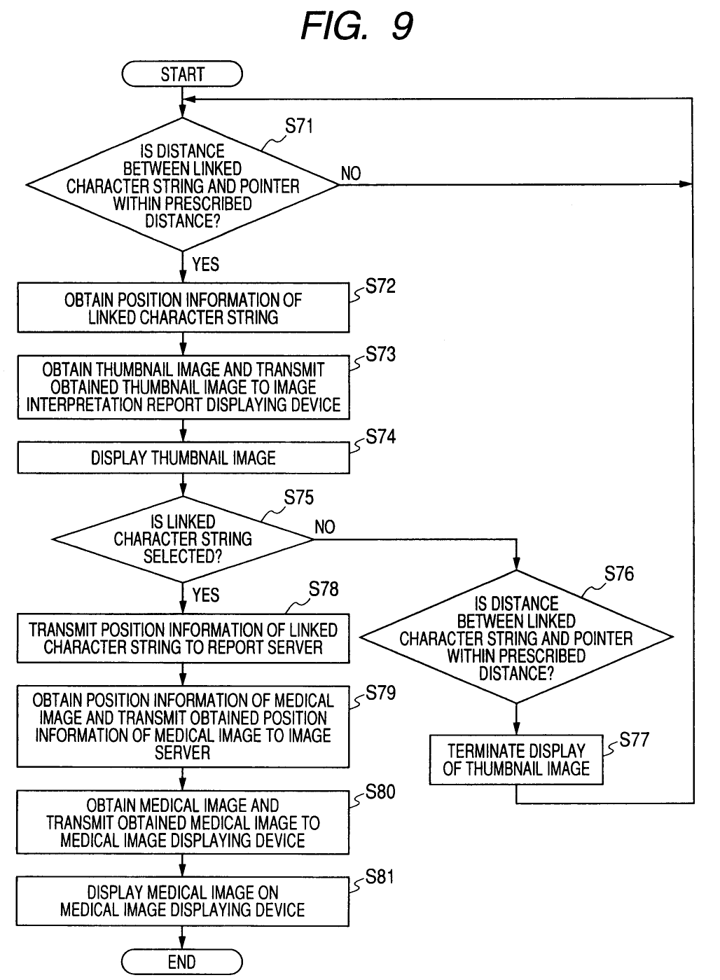

FIG. 9 is a flowchart showing a displaying process of the medical image on the image interpretation report display in case of storing the thumbnail image in PC 1.

When the image interpretation report is displayed on the image interpretation report displaying device 3, it is determined whether or not the distance between the linked character string 33 and the pointer 32 is within a prescribed distance (step S71). Then, if it is determined that the distance between the linked character string 33 and the pointer 32 approaches up to a prescribed distance in step S71, the position information of the linked character string 33 is obtained (step S72). When the position information of the character string 33 is transmitted, the thumbnail image correlated to the character string 33 is obtained. Moreover, the obtained thumbnail image is transmitted to the image interpretation report displaying device 3 (step S73). Then the thumbnail image 34 of the medical image correlated to the character string 33 is displayed on the image interpretation report displaying device 3 (step S74), as shown in FIG. 3. In addition, the following processes of step S75 to step S81 are the same as in FIG. 4. Accordingly, the description thereof will be omitted.

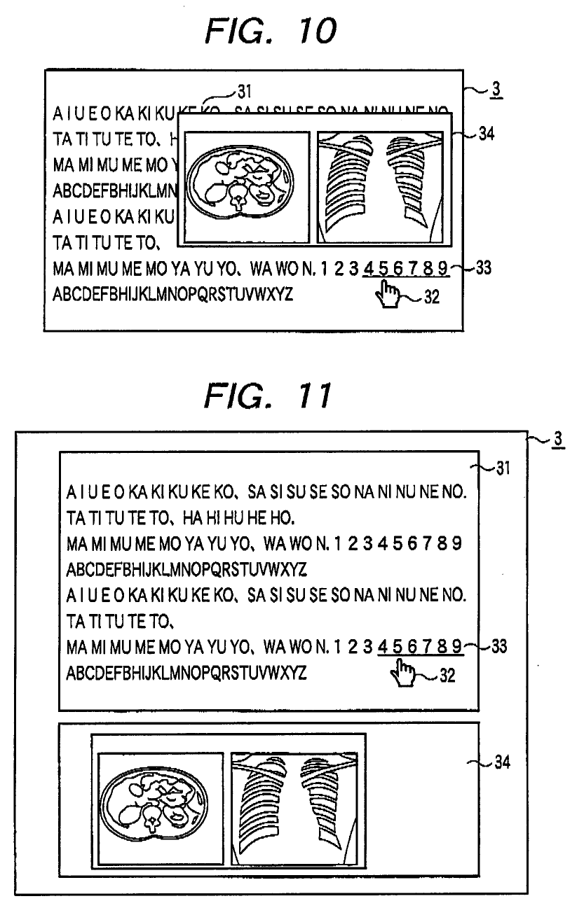

In addition, as a modification example of the embodiment of the invention, it is preferable that the thumbnail image is displayed at the position that does not interrupt a following image interpretation work. For example, as shown in FIG. 10, the position of the linked character string 33 and the pointer 32 is displayed so as not to hide. Moreover, as shown in FIG. 11, it is preferable to be provided with the display column for displaying only the thumbnail image 34, besides the opinion column 31.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image interpretation report preparing apparatus that accesses an image storage device storing a medical image and prepares an image interpretation report including at least link information for referring to the stored medical image, the apparatus comprising:
a display unit that displays the image interpretation report;
a mark displaying unit that displays a mark for designating the link information included in the image interpretation report, on the display unit; and
a thumbnail image displaying unit that displays a thumbnail image of the medical image correlated to the link information on the display unit, when the mark approaches the link information.

2. The apparatus according to claim 1, wherein the thumbnail image displaying unit terminates the display of the thumbnail image, when the mark goes away from the link information.

3. The apparatus according to claim 1, wherein the thumbnail image displaying unit changes the display position of the thumbnail image in accordance with the position of the link information.

4. An image interpretation report preparing apparatus that prepares an image interpretation report including link information for referring to a medical image stored in an image storage device, the apparatus comprising:
a display unit that displays the image interpretation report;
a mark displaying control unit that displays on the display unit a mark for designating link information included in the image interpretation report displayed on the display unit;
an input unit that operates the mark on a display screen of the display unit; and
a thumbnail image displaying control unit that displays on the display unit a thumbnail image of the medical image correlated to the link information, when the mark approaches the link information on the display screen by the operation of the input unit.

5. An image interpretation report preparing system comprising:
an image storage unit that stores a medical image;
an image interpretation report preparing unit that prepares an image interpretation report including at least link information for referring to the stored medical image;
a display unit that displays the image interpretation report;
a mark displaying unit that displays a mark for designating the link information included in the image interpretation report, on the display unit; and
a thumbnail image displaying unit that displays a thumbnail image of the medical image correlated to the link information on the display unit, when the mark approaches the link information.

6. The system according to claim 5, wherein the thumbnail image is stored in the image storage unit.

7. The system according to claim 5, further comprising an image interpretation report storing unit that stores the image interpretation report prepared by the image interpretation report preparing unit,
wherein the thumbnail image is stored in the image interpretation report storing unit.
